(19) United States
(12) Patent Application Publication
(10) Pub. No.: US 2017/0187931 A1
(43) Pub. Date: Jun. 29, 2017

(54) VEHICLE-MOUNTED CAMERA

(71) Applicant: NIDEC ELESYS CORPORATION, Kawasaki-shi (JP)

(72) Inventors: Motoyasu ONISHI, Kawasaki-shi (JP); Takeshi KOBAYASHI, Kawasaki-shi (JP)

(21) Appl. No.: 15/381,422

(22) Filed: Dec. 16, 2016

(30) Foreign Application Priority Data
Dec. 25, 2015 (JP) 2015-254737

(51) Int. Cl. H04N 5/225; B60R 1/00

(52) U.S. Cl. CPC H04N 5/2252; H04N 5/2253; B60R 1/00

(57) ABSTRACT

A vehicle-mounted camera includes a camera main assembly including a lens assembly, an image sensor located behind the lens assembly, and a camera circuit board located behind the image sensor and mounted with the image sensor, a tabular main circuit board located on the lower side of the camera main assembly and extending in the front-back direction and the left-right direction, and a connection flexible board that electrically connects the camera circuit board and the main circuit board. The connection flexible board includes an upper portion, a lower portion, and a bending portion located between the upper portion and the lower portion and crossing the outer peripheral edge of the main circuit board. The upper portion is connected to the camera circuit board at the front end portion.

This application claims the benefit of priority to Japanese Patent Application No. 2015-254737 filed on Dec. 25, 2015. The entire contents of Japanese Patent Application No. 2015-254737 are hereby incorporated herein by reference.

### BACKGROUND OF THE INVENTION

1. Field of the Invention

The present invention relates to a vehicle-mounted camera.

2. Description of the Related Art

There has been used a vehicle-mounted camera that performs image processing of an image captured by a camera attached to a vehicle to extract information regarding a traffic lane, a preceding vehicle, an oncoming vehicle, a person, or a traffic sign from the image. The vehicle-mounted camera is applied to a vehicle-mounted system that supports safe traveling of the vehicle. United States Patent Application Publication No. 2015/0042798 discloses a vehicle-mounted camera in which a hole piercing through a board in the vertical direction is provided in the board and a part of a camera body is placed in the hole to reduce the dimension in the height direction.

However, in the vehicle-mounted camera described in United States Patent Application Publication No. 2015/0042798, the air heated by a processing element or the like on the lower side of the board heats the camera body and affects the operation of the camera body when the air passes through the hole of the board.

### SUMMARY OF THE INVENTION

Preferred embodiments of the present invention provide a vehicle-mounted camera having high reliability.

A vehicle-mounted camera according to a first preferred embodiment of this application is a vehicle-mounted camera placed in an interior of a vehicle in a posture in which the vehicle-mounted camera extends along a window glass facing forward or rearward of a vehicle body, the vehicle-mounted camera being used to capture an image of a scene of a vehicle exterior. The vehicle-mounted camera includes: a camera main assembly disposed along an optical axis extending in the front-back direction, the camera main assembly including a lens assembly, an image sensor located behind the lens assembly, and a camera circuit board located behind the image sensor and mounted with the image sensor; a tabular main circuit board located on the lower side of the camera main assembly and extending in the front-back direction and the left-right direction; a connection flexible board that electrically connects the camera circuit board and the main circuit board; a cover housing that supports the camera main assembly and covers the camera main assembly and the main circuit board from above; and a base housing that covers the lower surface of the main circuit board. The connection flexible board includes: an upper portion located on the upper side of the main circuit board and connected to the camera circuit board; a lower portion located on the lower side of the main circuit board and connected to the lower surface of the main circuit board; and a bending portion located between the upper portion and the lower portion and crossing the outer peripheral edge of the main circuit board. The upper portion is connected to the camera circuit board at the front end portion of the upper portion.

With the preferred embodiments of the present invention, it is possible to provide vehicle-mounted cameras having high reliability.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a sectional schematic view of a vehicle body mounted with a vehicle-mounted camera according to a first preferred embodiment of the present invention.

FIG. 2 is an exploded perspective view of a vehicle-mounted camera according to the first preferred embodiment of the present invention.

FIG. 3 is a plan view of a main circuit board and a camera main assembly according to the first preferred embodiment of the present invention.

FIG. 4 is a side view of the main circuit board and the camera main assembly according to the first preferred embodiment of the present invention.

FIG. 5 is a rear perspective view of the main circuit board and the camera main assembly according to the first preferred embodiment of the present invention.

FIG. 6 is an exploded perspective view of the camera main assembly according to the first preferred embodiment of the present invention.

FIG. 7 is a rear perspective view of a main circuit board and a camera main assembly according to Variation 1 of a preferred embodiment of the present invention.

FIG. 8 is a rear perspective view of a main circuit board and a camera main assembly according to Variation 2 of a preferred embodiment of the present invention.

### DETAILED DESCRIPTION OF THE PREFERRED EMBODIMENTS

A vehicle-mounted camera 100 according to a preferred embodiment of the present invention will be described with reference to the drawings.

Note that, in the drawings referred to in the following explanation, characterizing portions are sometimes enlarged and shown for convenience for the purpose of emphasizing the characterizing portions. Dimension ratios and the like of components are not always the same as actual dimension ratios and the like. For the same purpose, non-characterizing portions are sometimes omitted.

In the following explanation of the vehicle-mounted camera 100, the vehicle width direction of a vehicle body 1 at the time when the vehicle-mounted camera 100 is attached to the vehicle body 1 is defined as the width direction or left-right direction of the vehicle-mounted camera 100, the front-back direction of the vehicle body 1 is defined as the front-back direction of the vehicle-mounted camera 100, and the vertical direction of the vehicle body 1 is defined as the vertical direction of the vehicle-mounted camera 100. Note that the postures and the layout of members of the vehicle-mounted camera 100 are illustrative only and can be modified as desired without departing from the spirit of the present invention.

In the following description, extending in the front-back direction (or extending to the front and the back) includes, in addition to strictly extending in the front-back direction, extending in a direction tilting in a range of less than 45° with respect to the front-back direction.

### First Preferred Embodiment

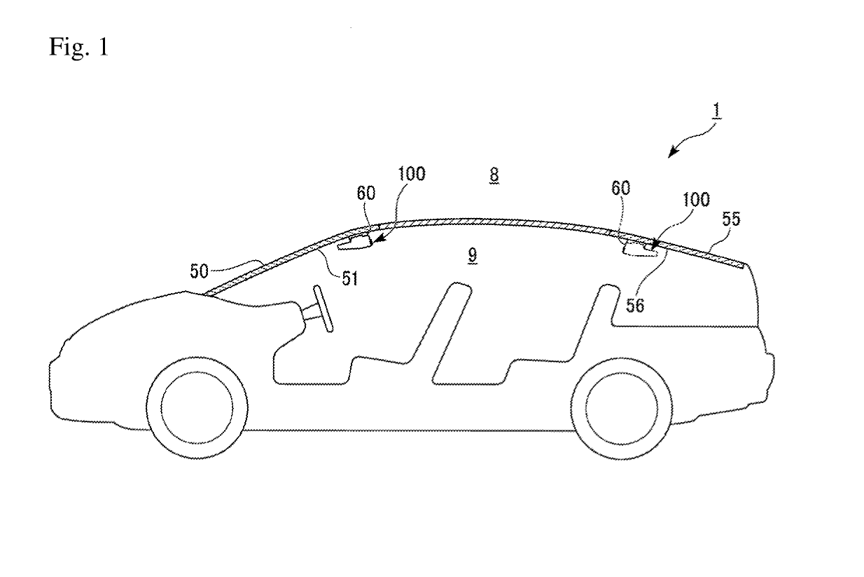

FIG. 1 is a sectional schematic view of the vehicle body 1 mounted with the vehicle-mounted camera 100 according to a first preferred embodiment of the present invention. The vehicle body 1 includes a window glass 50 facing forward (hereinafter, front window) and a window glass 55 facing rearward (hereinafter, rear window). The vehicle-mounted camera 100 is preferably attached to a glass surface 51 on a vehicle interior 9 side of the front glass 50 via an attachment member 60 and used to capture an image of a scene ahead of the vehicle body 1.

Note that, as indicated by an alternate long and two short dashes line in FIG. 1, the vehicle-mounted camera 100 may be attached to a glass surface 56 on the vehicle interior 9 side of the rear glass 55. When the vehicle-mounted camera 100 is attached to the rear glass 55, the vehicle-mounted camera 100 is used to capture an image of a scene behind the vehicle body 1.

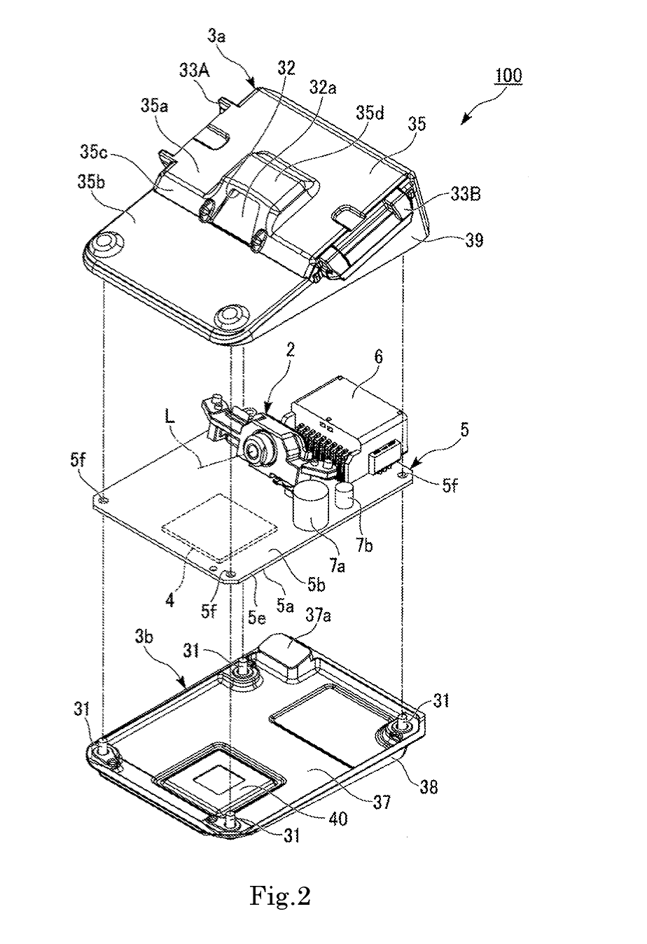

FIG. 2 is an exploded perspective view of the vehicle-mounted camera 100.

The vehicle-mounted camera 100 preferably includes a camera main assembly 2, a tabular main circuit board 5 located on the lower side of the camera main assembly 2, a cover housing 3a that covers the camera main assembly 2 and the main circuit board 5, and a base housing 3b that covers the lower surface of the main circuit board 5.

The main circuit board 5 processes video data captured by the camera main assembly 2. The main circuit board 5 transmits the video data to another apparatus. The main circuit board 5 preferably has a plate shape extending in the front-back direction and the left-right direction. The main circuit board 5 is preferably mounted with a processing circuit element 4, a connector 6, capacitors 7a and 7b, and the like.

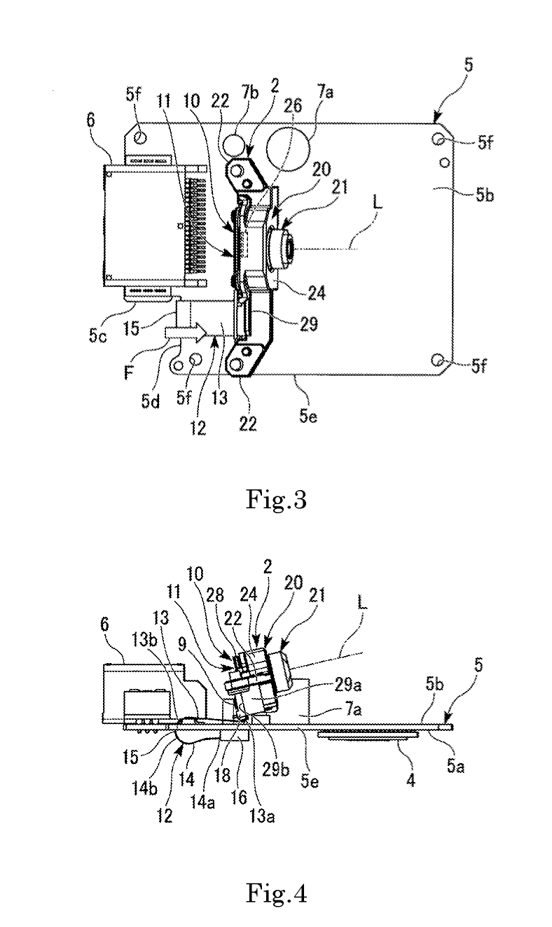

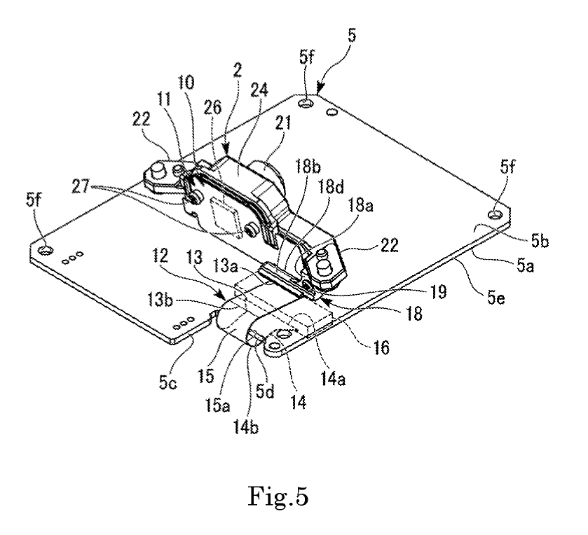

A plan view, a side view, and a rear perspective view of the main circuit board 5 and the camera main assembly 2 are respectively shown in FIGS. 3 to 5. Note that, in FIG. 5, components mounted on the main circuit board 5 are not shown for the sake of clarity.

The main circuit board 5 includes an upper surface 5b, a lower surface 5a, and an outer peripheral edge 5e forming a plan view external shape of the main circuit board 5. The main circuit board 5 preferably has a rectangular shape, a recess portion 5c being provided in one corner located in the rear among four corners of the rectangular shape. The inner side surface of the recess portion 5c defines a portion of the outer peripheral edge 5e. The recess portion 5c extends from one side and the rear of the main circuit board 5 in plan view.

In the main circuit board 5, four fixing holes 5f are provided, for example. Fixing screws 31 that fix the cover housing 3a and the base housing 3b are inserted into the fixing holes 5f, for example. Consequently, the main circuit board 5 is held between the cover housing 3a and the base housing 3b and fixed.

The main circuit board 5 divides a space surrounded by the cover housing 3a and the base housing 3b into upper and lower spaces. The upper and lower spaces of the main circuit board 5 communicate with each other through the recess portion 5c. Therefore, the air (hot air) heated by heat generation of the processing circuit element 4 located on the lower surface 5a side of the main circuit board 5 flows into the upper space via the recess portion 5c. That is, the recess portion 5c defines a channel that agitates the air in the upper and lower spaces partitioned by the main circuit board 5. According to this preferred embodiment, since the recess portion 5c is provided, the air heated on the lower side of the main circuit board 5 is less easily held up. It is possible to efficiently radiate heat using the entire cover housing 3a and the entire base housing 3b. Therefore, it is possible to significantly reduced or prevent the influence of, for example, a reduction of operation speed due to the heat generation of the processing circuit element 4.

The processing circuit element 4 is preferably provided in a region in the front of the lower surface 5a of the main circuit board 5. The processing circuit element 4 electronically processes an image captured by an image sensor 26 of the camera main assembly 2. More specifically, the processing circuit element 4 performs processing to extract various characteristic objects such as, for example, a vehicle, a pedestrian, and a traffic lane concerning visual information focused on the image sensor 26. The processing circuit element 4 is in contact with the base housing 3b via a heat radiation member 40 to efficiently radiate heat. Examples of the heat radiation member 40 include, for example, a heat radiation plate, a heat radiation sheet, and a heat radiation gel.

The connector 6 and the capacitors 7a and 7b are preferably provided in a region behind the upper surface 5b of the main circuit board 5. The connector 6 is adjacent to the recess portion 5c of the main circuit board 5 in the left-right direction. The connector 6 and the capacitors 7a and 7b are components having a relatively large dimension in the vertical direction among the components mounted on the main circuit board 5. Since the connector 6 and the capacitors 7a and 7b are mounted closer to the rear of the main circuit board 5, it is possible to prevent the connector 6 and the capacitors 7a and 7b from blocking the visual field of the camera main assembly 2 facing forward. A wire extending to an external apparatus (not shown) is connected to the connector 6. The connector 6 relays power supply and communication to the vehicle-mounted camera 100. The capacitors 7a and 7b define a portion of a power supply circuit.

The cover housing 3a supports the camera main assembly 2 and covers the camera main assembly 2 and the main circuit board 5 from above. As shown in FIG. 2, the cover housing 3a preferably includes a tabular top plate 35 and a peripheral edge portion 39 extending to the lower side from the peripheral edge of the top plate 35.

The peripheral edge portion 39 surrounds the camera main assembly 2 and the components (the connector 6, the capacitors 7a and 7b, etc.) mounted on the upper surface 5b of the main circuit board 5. The dimension in the vertical direction of the peripheral edge portion 39 gradually increases from the front to the rear. A not-shown opening is provided in a rear portion of the peripheral edge portion 39. The connector 6 mounted on the main circuit board 5 is exposed to the rear via the opening. The cover housing 3a is fixed to the base housing 3b by screws in the peripheral edge portion 39.

Attaching projections 33A and 33B are respectively provided on the width direction both sides of the peripheral edge portion 39. The attaching projections 33A and 33B are structured to fit in the attachment member 60 fixed to the vehicle body 1.

The top plate 35 preferably includes a top plate front portion 35b, a top plate rear portion 35a, and a riser 35c. The top plate front portion 35b is located in a front region in the top plate 35. The top plate rear portion 35a is located behind and on the upper side of the top plate front portion 35b. The riser 35c is located in the boundary between the top plate rear portion 35a and the top plate front portion 35b.

A camera housing portion 35d is provided in the width direction center of the top plate rear portion 35a. The camera housing portion 35d has a shape projecting above the top plate rear portion 35a. The camera main assembly 2 is housed in a space below the camera housing portion 35d.

In the riser 35c, a viewing window 32 is provided in a portion located in the front of the camera housing portion 35d. The viewing window 32 is an opening through which an optical axis L of the camera main assembly 2 passes. The camera main assembly captures an image on the outside of the vehicle through the viewing window 32. The viewing window 32 is closed by a transparent plate 32a.

The base housing 3b covers the main circuit board 5 from the lower side. As shown in FIG. 2, the base housing 3b includes a sidewall portion 38 and a bottom portion 37. The heat radiation member 40 is provided in a front portion of the bottom portion 37 in a position brought into contact with the processing circuit element 4.

The base housing 3b gradually decreases in the vertical dimension from the rear to the front. In the bottom portion 37, a thick portion 37a disposed to overlap the recess portion 5c of the main circuit board 5 when viewed from the vertical direction is provided. That is, the base housing 3b includes the thick portion 37a. The thick portion 37a is in contact with the hot air that passes the recess portion 5c. The base housing 3b locally has a large heat capacity in the thick portion 37a. Therefore, it is possible to effectively cool the hot air that passes the recess portion 5c.

The base housing 3b is preferably fixed to the cover housing 3a by, for example, four fixing screws 31. The cover housing 3a and the base housing 3b define an internal space that houses the main circuit board 5, the components mounted on the main circuit board 5, and the camera main assembly 2.

In this preferred embodiment, one or both of the cover housing 3a and the base housing 3b are preferably made of aluminum or an aluminum alloy. When the cover housing 3a and the base housing 3b are made of aluminum or an aluminum alloy, it is possible to increase a heat capacity and efficiently cool housed objects.

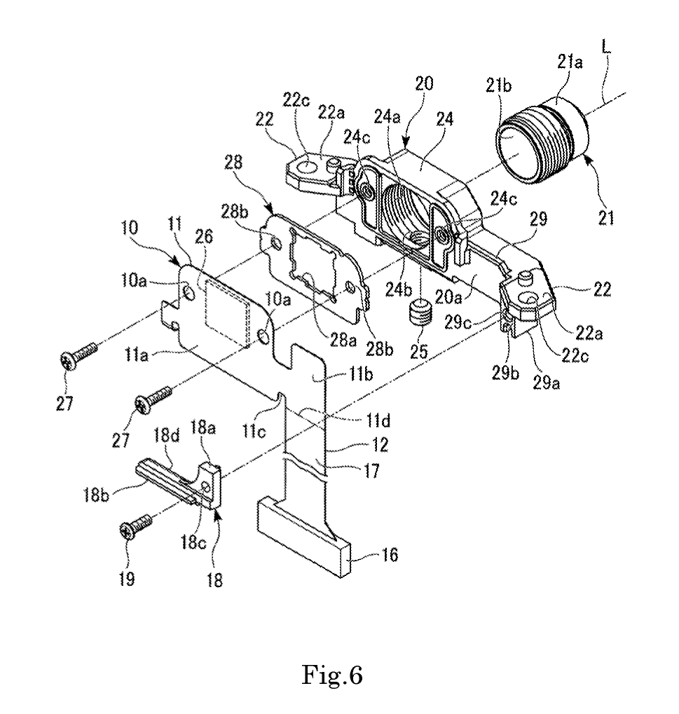

FIG. 6 is an exploded perspective view of the camera main assembly 2. The camera main assembly 2 is a device that captures an image of a front scene of the vehicle body 1. The camera main assembly 2 is fixed to the lower surface of the top plate 35 of the cover housing 3a by screws.

The camera main assembly 2 includes one optical axis L extending in the front-back direction. The camera main assembly 2 preferably includes a lens assembly 21, a base 20, a set screw 25, a flexible printed circuit board 10, the image sensor 26, a retaining plate 28, a pair of fixing screws 27, a pressing member (a pressing portion) 18, and a pressing member fixing screw 19. The flexible printed circuit board 10 preferably includes a camera circuit board portion (a camera circuit board) 11 and a connection flexible board portion (a connection flexible board) 12. The lens assembly 21, the image sensor 26, and the camera circuit board portion 11 are disposed in order along the optical axis L.

The lens assembly 21 preferably includes a plurality of lenses 21b, optical axes of which are matched, and a cylinder portion 21a having a cylindrical shape that holds the plurality of lenses 21b. Male screw threads are preferably provided on the outer circumferential surface of the cylinder portion 21a. The common optical axis of the plurality of lenses 21b is the optical axis L of the camera main assembly 2. The lens assembly 21 projects to the front of the base unit 20 and is fixed to the base unit 20. The image sensor 26 is disposed behind the lens assembly 21.

The base 20 is made of, for example, a resin material. The base 20 preferably includes a base body 24, an interposed portion 29, and a pair of camera side pedestals 22. The base body 24 and the interposed portion 29 are continuously disposed on the left-right direction. The base body 24 and the interposed portion 29 include a rear surface 20a continuously disposed thereon. The pair of camera side pedestals 22 is respectively located on the left and right both sides of the base unit 20.

A fitting hole 24a having the optical axis L as a center axis and a pair of screw holes 24c located on the left-right direction both sides of the fitting hole 24a are provided on the rear surface 20a of the base body 24.

Female screw threads are preferably provided on the inner circumferential surface of the fitting hole 24a. The lens assembly 21 is inserted into the fitting hole 24a. In the inner circumferential surface of the fitting hole 24a, a screw hole 24b piercing through the base body 24 in a direction perpendicular to the optical axis L and to the lower side is provided. The set screw 25 for tightening the lens assembly 21 from the radial direction and fixing the lens assembly 21 is inserted into the screw hole 24b.

The fixing screws 27 that support the retaining plate 28 and the flexible printed circuit board 10 via an adhesive (not shown in the figure) are inserted into the screw holes 24c.

The interposed portion 29 is located on the left-right direction one side of the base body 24. The interposed portion 29 is interposed between the base body 24 and one camera side pedestal 22. The interposed portion 29 includes, near the end portion on the camera side pedestal 22, a pedestal 29a projecting rearward. The pedestal 29a preferably includes a pedestal surface 29b to fix a pressing member. The pedestal surface 29b is a surface facing rearward. A screw hole 29c, into which the pressing member fixing screw 19 is inserted, is provided in the pedestal surface 29b.

The pair of camera side pedestals 22 includes camera side pedestal surfaces 22a facing the upper side. Through-holes 22c vertically piercing through the camera side pedestals 22 from the camera side pedestal surfaces 22a are provided in the camera side pedestals 22. Screws (not shown in the figure) inserted into screw holes (not shown in the figure) provided in the lower surface of the cover housing 3a are inserted into the through-holes 22c. The camera main assembly 2 is fixed to the cover housing 3a in the pair of camera side pedestals 22.

The image sensor 26 acquires visual information of an outside world as an image. The image sensor 26 is located behind the lens assembly 21 and captures a subject image focused through the lens assembly 21. In this preferred embodiment, the image sensor 26 preferably has a rectangular shape, for example. The image sensor 26 is mounted on the flexible printed circuit board 10. As the image sensor 26, for example, a CMOS image sensor is used.

As shown in FIG. 3, the image sensor 26 is located in front of the recess portion 5c of the main circuit board 5 when viewed from the vertical direction. The main circuit board 5 is disposed along the front glass 50 in a state in which the vehicle-mounted camera 100 is attached to the vehicle. That is, the main circuit board 5 is used in a posture farther inclined upward toward the rear. Since the hot air rises against gravity, the hot air flows rearward on the upper side of the main circuit board 5. Since the image sensor 26 is disposed in front of the recess portion 5c, it is possible to significantly reduce or prevent the hot air from flowing toward the image sensor 26 and reduce a temperature rise of the image sensor 26.

The image sensor 26 and the recess portion 5c are disposed in different positions when viewed from the front-back direction. Consequently, the hot air reaching the upper side of the main circuit board 5 via the recess portion 5c less easily reaches the image sensor 26. Further, the image sensor 26 and the connector 6 are disposed in overlapping positions when viewed from the front-back direction. The connector 6 is a component that has the largest dimension in the vertical direction among the components mounted on the main circuit board 5. The connector 6 limits, as shown in FIG. 3, the direction of a channel F of the hot air reaching the upper side of the main circuit board 5 via the recess portion 5c. Since the connector 6 and the image sensor 26 are disposed to be superimposed in the front-back direction, the hot air reaching the upper side of the main circuit board 5 less easily flows in the left-right direction. Consequently, it is possible to significantly reduce or prevent the hot air from passing near the image sensor 26 and reduce the temperature rise of the image sensor 26.

As shown in FIG. 6, the flexible printed circuit board 10 includes the camera circuit board portion 11 and the connection flexible board portion 12. The camera circuit board portion 11 is opposed to the rear surface 20a of the base 20. The camera circuit board portion 11 includes a first region 11a and a second region 11b arranged in the left-right direction across a constricted portion 11c. The first region 11a is located behind the base body 24 of the base 20. The second region 11b is located behind the interposed portion 29. The image sensor 26 is mounted on the camera circuit board portion 11 in the first region 11a. A pair of through-holes 10a is preferably provided in the first region 11a. The through-holes 10a are located on the left and right both sides of the image sensor 26. The fixing screws 27 are inserted through the through-holes 10a.

The connection flexible board portion 12 is continuous to the camera circuit board portion 11 at a lower end edge 11d of the second region 11b. That is, the camera circuit board portion 11 is connected to the connection flexible board portion 12 at the lower end edge 11d. Note that the lower end edge 11d is a portion facing the lower side in the outer peripheral edge forming the external shape of the camera circuit board portion 11.

The connection flexible board portion 12 includes a body portion 17 having flexibility and a terminal portion 16. The connection flexible board portion 12 will be described in detail below.

The retaining plate 28 is preferably, for example, a flat plate made of metal. A retaining hole 28a is provided in the center of the retaining plate 28. The shape of the retaining hole 28a preferably is a rectangular shape conforming to the plan view external shape of the image sensor 26. The inner circumferential surface of the retaining hole 28a is fixed to the outer circumferential surface of the image sensor 26 via an adhesive (not shown in the figure). The retaining plate 28 retains the image sensor 26 via the adhesive. A pair of through-holes 28b piercing through the retaining plate 28 in the optical axis L direction is provided on the X direction both sides of the retaining hole 28a. The fixing screws 27 are inserted through the through-holes 28b.

The pair of fixing screws 27 is inserted into the screw holes 24c of the base 20 passing through the through-holes 10a of the flexible printed circuit board 10 and the through-holes 28b of the retaining plate 28. The fixing screws 27 are fixed to the inner circumferential surfaces of the through-holes 10a and 28b via an adhesive (not shown in the figure). That is, the fixing screws 27 support the flexible printed circuit board 10 and the retaining plate 28 via the adhesive. With the camera main assembly according to this preferred embodiment, it is possible to highly accurately fix the image sensor 26 by hardening the adhesive in a state in which the flexible printed circuit board 10 and the retaining plate 28 are accurately aligned.

The pressing member 18 includes a supporting portion 18a and a bar-shaped portion 18b extending to the left-right direction one side from the supporting portion 18a. A through-hole 18c piercing through the supporting portion 18a in the front-back direction is provided in the supporting portion 18a. The pressing member fixing screw 19 is inserted into the screw hole 29c of the pedestal surface 29b passing through the through-hole 18c, such that the pressing member 18 is fixed to the base 20.

The bar-shaped portion 18b is located on the lower side of the supporting portion 18a. The bar-shaped portion 18b includes a contact surface 18d that is in contact with the connection flexible board portion 12. The contact surface 18d extends in the left-right direction along the length direction of the bar-shaped portion 18b. The contact surface 18d is opposed to the rear surface 20a of the base 20. The contact surface 18d is a curved surface curved at a predetermined curvature radius along the circumferential direction of the bar-shaped portion 18b.

The connection flexible board portion 12 electrically connects the camera circuit board portion 11 of the camera main assembly 2 and the main circuit board 5. As shown in FIG. 5, the connection flexible board portion 12 preferably includes an upper portion 13 located on the upper side of the main circuit board 5, a lower portion 14 located on the lower side of the main circuit board 5, and a bending portion 15 crossing the outer peripheral edge 5e of the main circuit board 5.

The upper portion 13 extends in the front-back direction when the left-right direction is defined as width direction. The upper portion 13 includes a front end portion 13a and a rear end portion 13b at the front and rear both ends. The upper portion 13 is integrally connected to the camera circuit board portion 11 at the front end portion 13a. The upper portion 13 passes, at the front end portion 13a, the lower side of the pressing member 18 extending in the width direction of the upper portion 13. The upper portion 13 is in contact with the contact surface 18d of the pressing member 18 at the front end portion 13a. The upper portion curves to surround the bar-shaped portion 18b in the circumferential direction while being supported by the contact surface 18d.

According to this preferred embodiment, the connection flexible board portion 12 is supported by the contact surface 18d extending in the left-right direction of the pressing member 18 and curves downward and then curves rearward. Therefore, handling of the connection flexible board portion 12 is stabilized. It is possible to significantly reduce or prevent damage to the connection flexible board portion 12 in a manufacturing process. Since the connection flexible board portion 12 curves along the contact surface 18d, the connection flexible board portion 12 is not curved at an excessively small curvature radius. It is possible to reduce a load applied to wires inside the connection flexible board portion 12.

The lower portion 14 extends in the front-back direction when the left-right direction is defined as width direction. The lower portion 14 includes a front end portion 14a and a rear end portion 14b at the front rear both ends. The terminal portion 16 is fixed to the front end portion 14a of the lower portion 14. The lower portion 14 is connected to the lower surface 5a of the main circuit board 5 in the terminal portion 16.

The bending portion 15 is located between the rear end portion 13b of the upper portion 13 and the rear end portion 14b of the lower portion 14 and integrally connects the rear end portion 13b and the rear end portion 14b. The bending portion 15 is bent with an inner circumference side 15a thereof facing forward. The bending portion is disposed on the inner side of the recess portion 5c of the main circuit board 5. The inner circumference side 15a of the bending portion 15 is opposed to a recess rear edge 5d facing the rear of the recess portion 5c in the outer peripheral edge 5e of the main circuit board 5. That is, the bending portion 15 is disposed with the inner circumference side 15a thereof being opposed to the outer peripheral edge 5e on the rear side of the main circuit board 5.

The connection flexible board portion 12 according to this preferred embodiment preferably includes the upper portion 13 extending forward with respect to the recess portion 5c and connected to the camera circuit board portion 11 at the front end portion 13a. Consequently, it is possible to dispose the camera circuit board portion 11, on which the image sensor 26 is mounted, to be separated from the recess portion 5c functioning as a channel of the hot air. Therefore, it is possible to significantly reduce or prevent the temperature rise of the image sensor 26 and improve reliability of the operation of the image sensor 26.

Note that, in this preferred embodiment, the camera circuit board portion 11 and the connection flexible board portion 12 preferably are one continuous flexible printed circuit board 10. However, the camera circuit board portion 11 and the connection flexible board portion 12 may be separate bodies. In this case, a terminal portion for connection to the camera circuit board portion 11 may be provided at one end of the connection flexible board portion 12. Further, one or both of the camera circuit board portion 11 and the connection flexible board portion 12 may be defined by a rigid board.

### Variation 1 of a Preferred Embodiment

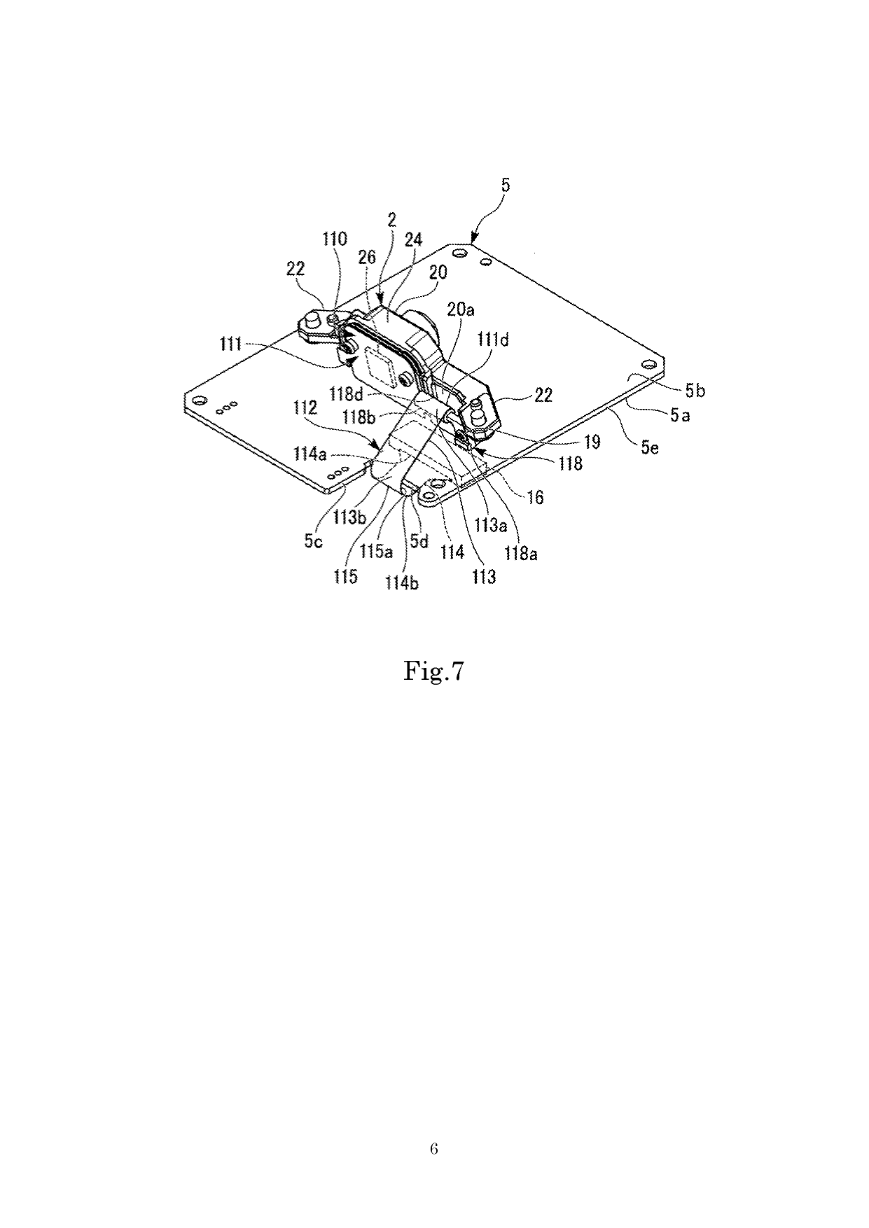

A pressing member 118 and a flexible printed circuit board 110 according to Variation 1 of a preferred embodiment of the present invention adoptable in the vehicle-mounted camera 100 will be described with reference to FIG. 7. According to this variation, it is possible to achieve effects same as the effects of the above-discussed preferred embodiment. Note that components same as the components in the preferred embodiment are denoted by the same reference numerals and signs and explanation of the components is omitted.

The pressing member 118 preferably includes a supporting portion 118a and a bar-shaped portion 118b located on the upper side of the supporting portion 118a and extending in the left-right direction one side. The bar-shaped portion 118b includes a contact surface 118d that is in contact with a connection flexible board portion 112. The contact surface 118d extends in the left-right direction along the length direction of the bar-shaped portion 118b.

The flexible printed circuit board 110 includes a camera circuit board portion 111 opposed to the rear surface 20a of the base 20 and the connection flexible board portion 112 that electrically connects the camera circuit board portion 111 and the main circuit board 5. The camera circuit board portion 111 is connected to the connection flexible board portion 112 at an upper end edge 111d. Note that the upper end edge 111d is a portion facing the upper side in the outer peripheral edge forming the external shape of the camera circuit board portion 111.

The connection flexible board portion 112 preferably includes an upper portion 113 located on the upper side of the main circuit board 5, a lower portion 114 located on the lower side of the main circuit board 5, and a bending portion 115 crossing the outer peripheral edge 5e of the main circuit board 5.

The upper portion 113 includes a front end portion 113a and a rear end portion 113b at the front and rear both ends. The upper portion 113 is integrally connected to the camera circuit board portion 111 at the front end portion 113a. The upper portion 113 is in contact with the contact surface 118d of the pressing member 118 at the front end portion 113a and curves while being supported by the contact surface 118d. The upper portion 113 passes, at the front end portion 113a, the upper side of the pressing member 118 extending in the width direction of the upper portion 113. The upper portion 113 is in contact with the contact surface 118d of the pressing member 118 at the front end portion 113a. The upper portion 113 curves upward and then curves downward to surround the bar-shaped portion 118b in the circumferential direction while being supported by the contact surface 118d.

The lower portion 114 includes a front end portion 114a and a rear end portion 114b at the front rear both ends. The terminal portion 16 is fixed to the front end portion 114a of the lower portion 114.

The bending portion 115 is located between the rear end portion 113b of the upper portion 113 and the rear end portion 114b of the lower portion 114 and integrally connects the rear end portion 113b and the rear end portion 114b. The bending portion 115 is bent with an inner circumference side 115a thereof facing forward. The bending portion 115 is disposed with the inner circumference side 115a thereof opposed to the outer peripheral edge 5e on the rear side of the main circuit board 5.

### Variation 2 of a Preferred Embodiment

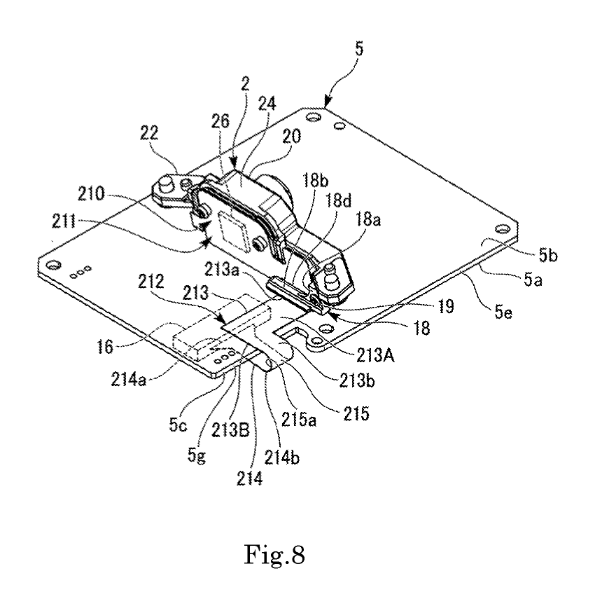

A flexible printed circuit board 210 according to Variation 2 of a preferred embodiment of the present invention adoptable in the vehicle-mounted camera 100 will be described with reference to FIG. 8. According to this variation, it is possible to achieve effects same as the effects of the above-described preferred embodiment. Note that components same as the components in the preferred embodiment are denoted by the same reference numerals and signs and explanation of the components is omitted.

The flexible printed circuit board 210 preferably includes a camera circuit board portion 211 and a connection flexible board portion 212. The connection flexible board portion 212 includes an upper portion 213 located on the upper side of the main circuit board 5 and having an L shape, a lower portion 214 located on the lower side of the main circuit board 5, and a bending portion 215 crossing the outer peripheral edge 5e of the main circuit board 5.

The upper portion 213 is preferably L-shaped in plan view and includes a front end portion 213a and a right end portion 213b. The upper portion 213 includes a front-rear extending portion 213A extending to the front and the rear and a left-right extending portion 213B extending to the left and the right. The front-rear extending portion 213A is connected to the camera circuit board portion 211 at the front end portion 213a. The left-right extending portion 213B extends to the left-right direction one side from the rear end of the front-rear extending portion 213A. The left-right extending portion 213B is integrally connected to the bending portion 215 at the right end portion 213b.

The lower portion 214 extends in the left-right direction. The lower portion 214 includes a right end portion 214b and a left end portion 214a respectively at the left-right direction both ends. The terminal portion 16 is fixed to the left end portion 214a of the lower portion 214. The lower portion 214 is integrally connected to the bending portion 215 at the right end portion 214b.

The bending portion 215 is bent with an inner circumference side 215a thereof facing toward the left and with the outer circumference side facing toward the right. The bending portion 215 is disposed on the inner side of the recess portion 5c of the main circuit board 5. The inner circumference side 215a of the bending portion 215 is opposed to a recess side edge 5g, facing the side of the recess portion 5c, among the outer peripheral edge 5e of the main circuit board 5. That is, the bending portion 215 is disposed with the inner circumference side 215a thereof opposed to the outer peripheral edge 5e on the side of the main circuit board 5.

Preferred embodiments and variations of the present invention are described above. However, the components, the combinations of the components, and the like in the preferred embodiments and the variations are examples. Addition, omission, replacement, and other changes of components are possible within a range not departing from the spirit of the present invention. The present invention is not limited by the preferred embodiments and variations thereof.

For example, in the preferred embodiments and variations, the recess portion 5c of the main circuit board 5 preferably extends from the rear and the side toward the inner side in the external shape of the main circuit board 5. However, the recess portion 5c of the main circuit board 5 may extend only from the side toward the inner side or may extend only from the rear toward the inner side.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vehicle-mounted camera to be placed in an interior of a vehicle in a posture in which the vehicle-mounted camera extends along a window glass facing forward or rearward of a vehicle body, the vehicle-mounted camera being used to capture an image of a scene of a vehicle exterior, the vehicle-mounted camera comprising:
a camera main assembly including a lens assembly with an optical axis extending in a front-back direction, the camera main assembly including an image sensor located behind the lens assembly, and a camera circuit board located behind the image sensor and mounted with the image sensor;
a tabular main circuit board located on a lower side of the camera main assembly and extending in the front-back direction and a left-right direction;
a connection flexible board that electrically connects the camera circuit board and the main circuit board;
a cover housing that supports the camera main assembly and covers the camera main assembly and the main circuit board from above; and
a base housing that covers a lower surface of the main circuit board; wherein
the connection flexible board includes:
an upper portion located on an upper side of the main circuit board and connected to the camera circuit board;
a lower portion located on a lower side of the main circuit board and connected to the lower surface of the main circuit board; and
a bending portion located between the upper portion and the lower portion and crossing an outer peripheral edge of the main circuit board; and
the upper portion is connected to the camera circuit board at a front end portion of the upper portion.

2. The vehicle-mounted camera according to claim 1, wherein the camera circuit board and the connection flexible board are portions of one continuous flexible printed circuit board.

3. The vehicle-mounted camera according to claim 1, wherein the camera circuit board is connected to the connection flexible board at an upper end edge of the camera circuit board.

4. The vehicle-mounted camera according to claim 1, wherein the camera circuit board is connected to the connection flexible board at a lower end edge of the camera circuit board.

5. The vehicle-mounted camera according to claim 1, wherein the camera main assembly includes a pressing portion including a contact surface extending in the left-right direction; and
the connection flexible board is in contact with the contact surface and bends while being supported by the contact surface.

6. The vehicle-mounted camera according to claim 2, wherein
the camera main assembly includes a pressing portion including a contact surface extending in the left-right direction; and
the connection flexible board is in contact with the contact surface and bends while being supported by the contact surface.

7. The vehicle-mounted camera according to claim 1, wherein
the main circuit board includes a recess portion extending from a rear or a side thereof;
the bending portion is disposed on an inner side of the recess portion; and
the image sensor is located in front of the recess portion when viewed from a vertical direction with respect to the main circuit board.

8. The vehicle-mounted camera according to claim 2, wherein
the main circuit board includes a recess portion extending from a rear or a side thereof;
the bending portion is disposed on an inner side of the recess portion; and
the image sensor is located in front of the recess portion when viewed from a vertical direction with respect to the main circuit board.

9. The vehicle-mounted camera according to claim 6, wherein
the main circuit board includes a recess portion extending from a rear or a side thereof;
the bending portion is disposed on an inner side of the recess portion; and
the image sensor is located in front of the recess portion when viewed from a vertical direction with respect to the main circuit board.

10. The vehicle-mounted camera according to claim 7, wherein the image sensor and the recess portion are disposed in different positions when viewed along the front-back direction.

11. The vehicle-mounted camera according to claim 8, wherein the image sensor and the recess portion are disposed in different positions when viewed along the front-back direction.

12. The vehicle-mounted camera according to claim 9, wherein the image sensor and the recess portion are disposed in different positions when viewed along the front-back direction.

13. The vehicle-mounted camera according to claim 10, further comprising a connector mounted on the upper side of the main circuit board behind the camera main assembly; wherein
the image sensor and the connector are disposed in at least partly overlapping positions when viewed along the front-back direction.

14. The vehicle-mounted camera according to claim 11, further comprising a connector mounted on the upper side of the main circuit board behind the camera main assembly; wherein
the image sensor and the connector are disposed in at least partly overlapping positions when viewed along the front-back direction.

15. The vehicle-mounted camera according to claim 12, further comprising a connector mounted on the upper side of the main circuit board behind the camera main assembly; wherein
the image sensor and the connector are disposed in at least partly overlapping positions when viewed along the front-back direction.

16. The vehicle-mounted camera according to claim 7, wherein the base housing includes a thick portion disposed to overlap the recess portion when viewed from the vertical direction of the main circuit board.

17. The vehicle-mounted camera according to claim 7, wherein one or both of the cover housing and the base housing are made of aluminum or an aluminum alloy.

18. The vehicle-mounted camera according to claim 7, wherein the bending portion is disposed with an inner circumference side of the bending portion opposed to an outer peripheral edge on a rear side of the main circuit board.

19. The vehicle-mounted camera according to claim 7, wherein the bending portion is disposed with an inner circumference side of the bending portion opposed to an outer peripheral edge on a side of the main circuit board.

20. The vehicle-mounted camera according to claim 7, wherein the connection flexible board includes a flexible body portion and a terminal portion located at one end or both ends of the body portion.
